(19) United States
(12) Patent Application Publication
(10) Pub. No.: US 2004/0252839 A1
(43) Pub. Date: Dec. 16, 2004

(54) Method and device for collecting and displaying data transmitted by electromagnetic waves

(76) Inventors: Luc Deborgies, Chatillon (FR); Georges Liberman, Montreuil/Bois (FR)

Correspondence Address: HARRISON & EGBERT, 412 MAIN STREET, 7TH FLOOR, HOUSTON, TX, 77002, US

(21) Appl. No.: 10/312,236

(22) PCT Filed: Jun. 6, 2001
(86) PCT No.: PCT/FR01/02181

(30) Foreign Application Priority Data
Jul. 7, 2000 (FR) 00/08900

(51) Int. Cl. G08B 5/22; H04K 1/00

(52) U.S. Cl. 380/271; 713/172

(57) ABSTRACT

A method which includes transmitting data by electromagnetic waves to at least a reception device, in receiving the data at the reception device and in displaying part at least of the data at the reception device. The method is characterized in that it includes displaying the data, prior to recording part at least of the data received by the device at the removable storing mechanism which the device receives and/or only after controlling whether the display is authorized or appropriate on the basis of the data pre-recorded in the removable storage mechanism. The invention also concerns a device for implementing the method.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This invention relates to a method for transmitting data by electromagnetic waves, receiving these data at the level of a device and displaying at least a part of these data at the level of this device.

This invention also relates to a device for receiving and displaying data transmitted by electromagnetic waves, such a device being, in particular, designed capable of implementing such a method.

This invention relates to the field of the transmission of data by electromagnetic waves to a device and displaying these data at the level of this device.

### BACKGROUND OF THE INVENTION

There are already known devices that meet the above-mentioned description, such as pocket messengers, commonly referred to as “pagers”, capable of receiving and displaying data corresponding to e.g. a message or a telephone number the receiver of the message has to call.

### BRIEF SUMMARY OF THE INVENTION

The present invention is aimed at providing a new method as well as a new device designed capable of receiving and displaying data transmitted by electromagnetic waves.

To this end., this invention relates to a method for transmitting data by electromagnetic waves to at least one receiver device, for receiving these data at the level of such a receiver device and for displaying at least a part of these data at the level of this receiver device, characterized in that the display of these data is ensured before the recording of at least a part of the data received by the device is ensured at the level of removable storage means this device receives and/or only after having checked that this display was authorized or convenient according to data previously stored in said removable storage means.

According to another feature, the data are transmitted by frequency-modulated or amplitude-modulated electromagnetic waves, these data being carried by at least one sub-carrier, namely at least one RDS sub-carrier these electromagnetic waves include.

An additional feature consists in that one proceeds to selecting at least a part of the data received at the level of the device before proceeding to recording the selected data into the removable storage means.

In fact, when checking the authorization or the convenience of displaying data received by the device, a conditional-test of these data with reference to at least one piece of data previously stored at the level of the storage means is ensured.

The invention also relates to a device for receiving and displaying data transmitted by electromagnetic waves, characterized in that it includes:

means for receiving the transmitted data;

means capable of ensuring the display of at least a part of these transmitted data;

removable means for storing at least one piece of data corresponding to transmitted data and/or corresponding to data conditioning the display of at least one piece of transmitted data.

Another feature consists in that the device includes means for allowing selecting at least apart of the data received and displayed at the level of the display means.

An additional feature relates to the fact that the device includes means designed capable of ensuring storing, at the level of the storage means, at least one piece of data selected by means of the selecting means.

In addition, this device includes control means for storing the selected data at the level of the storage means.

According to another feature, said device includes means designed capable of ensuring a conditional-test for controlling or not the display of at least a part of the transmitted data, this according to at least one piece of data previously stored at the level of the storage means.

Another feature consists in that the conditional-test means are defined by means for ensuring a comparison between at least a part of the data received by the device and at least a part of the data previously stored at the level of the storage means.

According to still another feature, the conditional-test means are defined by means for ensuring a decryption of at least one encrypted piece of data transmitted to said device, such decryption being ensured based on at least one decryption key defining, at least partially, the data recorded at the level of the storage means.

An additional feature relates to the fact that the removable storage means are defined by a removable support which at least one electronic component for storing at least one piece of data is associated with.

In fact, the storage means are defined by a chip card.

According to another feature, the receiver means are designed capable of receiving data transmitted by amplitude-modulated and/or frequency-modulated electromagnetic waves.

An additional feature relates to the fact that the receiving means are designed capable of receiving data carried by at least one sub-carrier these amplitude-modulated and/or frequency-modulated electromagnetic waves include, namely a RDS sub-carrier.

In addition, the receiving means are completed with means designed capable of extracting numerical data, on the one band, comprised, at least partially, of said transmitted data and, on the other hand, contained in a set of data carried by said electromagnetic waves, namely by a sub-carrier of the latter.

The advantages of this invention reside in that it is possible to display, at the level of an appropriate device, data transmitted by electromagnetic waves.

Advantageously, such display occurs with a view to selecting at least certain transmitted data, in order to ensure the storage of these selected data at the level of a removable memory aimed at being removed from the device, namely for using these data at the level of an adequate apparatus.

According to another advantage ofthe invention, the display occurs only after having checked that such display is authorized or convenient, such checking being ensured in the light of data having been previously stored at the level of said removable memory.

This invention will be better understood when reading the following description with reference to the attached drawing.

### BRIEF DESCRIPTION OF THE SEVERAL VIEWS OF THE DRAWINGS

FIG. 1 is a schematic view of an installation allowing implementing the method according to the invention and including at least one receiver device-shown in an exploded view;

FIG. 2 is a schematic and partly cross-sectional view of a receiver device shown in FIG. 1 and including storage means shown in dotted lines.

### DETAILED DESCRIPTION OF THE INVENTION

This invention relates to the field of transmission of data by waves to at least one receiver, as well as of the display of at least a part of these data at the level of such receiver.

In fact, this invention relates in particular to a method for transmitting data by electromagnetic waves to at least one receiver device 1, for receiving these data at the level of such a receiver device 1 and for displaying at least a part of these data at the level of this receiver device 1.

The method according to the invention consists in that the display of these data is ensured either before ensuring the storage of at least a part of the data received by the device 1 at the level of the removable storage means 2 this device 1 receives or only after having checked that this display was authorized or convenient, such a checking occurring based on data previously stored in said removable storage means 2.

The method according to the invention can also consist in that such a display is ensured, on the one hand, before ensuring the storing of at least a part of the data received by the device 1 at the level of the removable storage means 2 this device 1 receives and, on the other hand, only after having checked that this display was authorized or convenient according to data previously stored in said removable storage means 2.

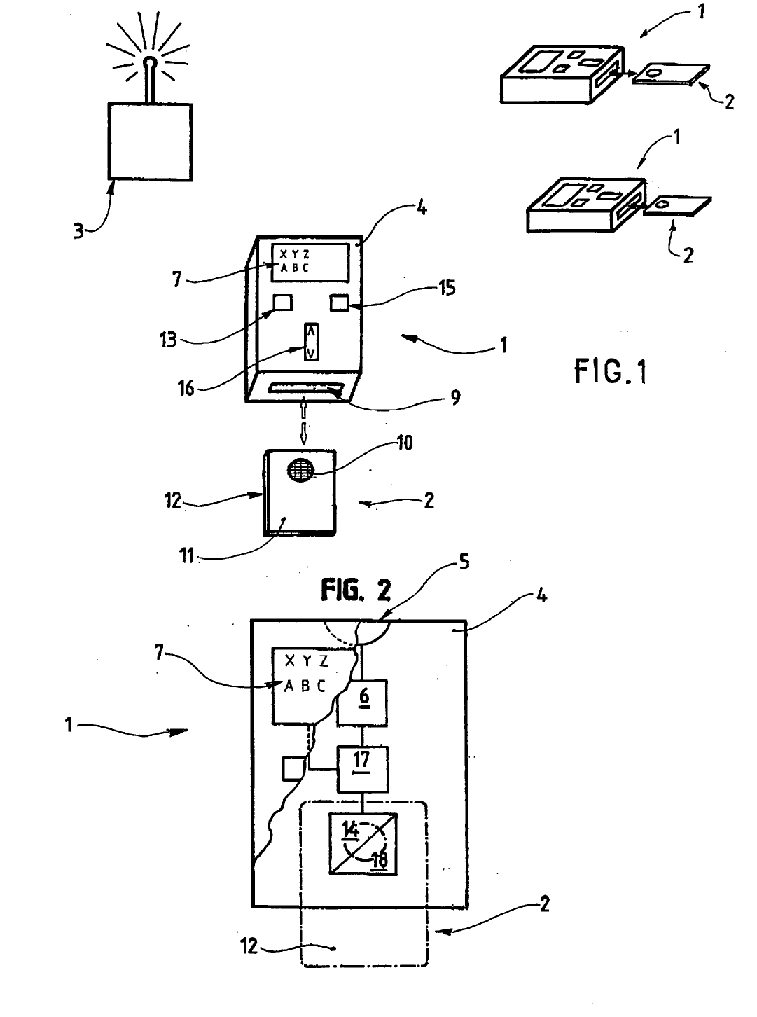

In order to implement such a method, this invention requires an adequate installation as shown in FIG. 1, such an installation including, on the one hand, at least one device 3 for sending the data transmitted by electromagnetic waves and, on the other hand, at least one device 1 for receiving this transmitted data.

Such a sender device 3 is designed capable of sending data aimed at being transmitted by amplitude-modulated and/or frequency-modulated electromagnetic waves.

These data are, as a matter of fact, aimed at being carried by at least one sub-carrier these amplitude-modulated and/or frequency-modulated electromagnetic waves include, in particular by at least one amplitude-modulated and/or frequency-modulated electromagnetic wave sub-carrier, namely a RDS sub-carrier.

In this respect, it should be noted that these electromagnetic waves (namely at least one sub-carrier of the latter) carry a set of data comprised of analogue data and/or digital data. According to a preferred embodiment, the digital data carried by these waves are at least partially formed by the data aimed at being transmitted to at least one receiver device.

Such a receiver device 1 adopts the form of a casing 4, preferably of an autonomous type, likely to be carried and adopting a reduced size that namely allows it to be put into a pocket.

As can be seen in the figures, such a casing 4 is provided with means 5 for receiving at least one piece of data, on the one hand, sent by said sender device 3 and, on the other hand, transmitted by amplitude-modulated and/or frequency-modulated electromagnetic waves.

According to a preferred embodiment of the invention, such receiving means 5 are designed capable of receiving data carried by at least one sub-carrier of these amplitude-modulated and/or frequency-modulated electromagnetic waves, in particular carried by an amplitude-modulated and/or frequency-modulated electromagnetic wave sub-carrier, namely a RDS sub-carrier.

Knowing that the electromagnetic waves (namely at least one sub-carrier of the latter) are likely to carry a set of (analogue and/or digital) data, said receiving means are completed with means 6 designed capable of ensuring an extraction, from this set of data, of digital data comprised, at least partially, of said data transmitted to said receiver device 1, carried by said electromagnetic waves and aimed at being displayed and/or stored at the level of said receiver device 1.

According to another feature of this invention, said receiver device 1 includes means 7 capable of ensuring the display of at least a part of the data sent by the sender device 3, carried by the electromagnetic waves and received by the receiving means 5.

Still another feature consists in that said receiver device 1 includes or receives means 2 for storing at least one piece of data. Such a stored piece of data corresponds, as a matter of fact, to a piece of data transmitted to said receiver device 1 and/or to a piece of data conditioning the display of at least one piece of data transmitted to this device 1.

It should be noted that these storage means 2 are, preferably, of a removable type and are designed capable, on the one hand, of being removed from said receiver device 1 and, on the other hand, of being implanted in the latter 1, namely at the level of a recess provided for this purpose and, in particular, by being inserted through an opening 9 provided for at the level of the casing 4.

In fact, these removable storage means 2 are defined by a removable support 11 which at least one electronic component 10 is associated with. In particular at the level of such an electronic component 10 is stored at least one piece of data.

A preferred embodiment of the invention consists in that the storage means 2 are defined by a chip card 12 inserted into said receiving device 1 through a slot or the like.

Another feature of the invention consists in that the receiving device 1 includes means 13 for allowing selecting at least a part of the data received and displayed at the level of the display means 7. Such selecting means 13 can be defined by a key, a button or the like said casing 4 includes.

This device 1 also includes means 14 designed capable of ensuring the storage, at the level of the removable storage means 2, of at least one piece of data corresponding to the data selected through the selecting means 13.

The receiving device 1 includes, in addition, control means 15 for storing, at the level of the storage means 2, at least one selected piece of data. Such control means 15 can also be defined by a key, a button, or the like the casing 4 includes, However, according to a particular embodiment, these control means 15 are defined by said selecting means 13.

This receiver device 1 can also be provided with means 16 designed capable of controlling the scrolling of the data displayed at the level of the display means 7, whereby such control means 16 can also consist of a key, a button or the like said casing 4 includes.

In this respect, it should be noted that the selecting means 13, storing means 14, control means for this storage 15, scrolling means 16 allow proceeding to selecting at least a part of the data received at the level of the device 1, in order to ensure the storage of a number of selected data into the removable storage means 2.

After having stored such data at the level of the removable storage means 2, it is possible to remove these storage means 2 from said receiving device 1, in order to check (the loading, erasing or the like) of these stored data through an adequate apparatus.

In this respect, it should be noted that these removable storage means 2 can include means capable of allowing identifying the holder and/or the user of said removable storage means 2.

According to another feature of this invention, said receiving means 1 includes means 17 designed capable of ensuring a conditional-test in order to control or not the display of at least a part of the data transmitted to said device 1, this based on at least one piece of data previously stored at the level of the storing means 2.

Said receiving means 1 also includes means 18 capable of ensuring the reading of the data stored at the level of the storage means 2, such reading means 18 being, as a matter of fact, associated with said test means 17.

In this respect, it should be noted that the data previously stored at the level of the storage means 2 can be defined by data relating to the holder of these storage means 2, namely in the form of a chip card 12.

These data relate, for example, to the profile of this holder (taste, centers of interests, consumer habits. . . ), so that the conditional-test means 17 are designed capable of judging about the convenience of controlling the display of determined transmitted data, this according to the profile.

These data can also relate to figures of a game the user has previously chosen and stored into the memory 2. The conditional-test means 17 can then be designed capable of controlling the display of the results of this game and, eventually, gains (data transmitted to the device 1) corresponding in particular to the figures chosen and stored in the memory 2.

These data can also be of such a kind as to authorize or not such a display, this namely according to the payment, pre-payment, of a subscription to a service consisting in supplying (through a transmission by electromagnetic waves) of data capable of being displayed at the level of the receiver device 1.

According to a particular embodiment, these conditional-test means 17 are defined by means for ensuring a comparison between at least a part of the data received by the device 1 and at least a part of the data previously stored at the level of the storage means 2. Such comparison means are then designed capable, in the event of coincidence (or non-coincidence, respectively) between the data compared, of controlling (or impeding, respectively) the display of at least one piece of data received by said device 1.

Another embodiment consists in that the conditional-test means 17 are formed by means for ensuring the decryption of at least one piece of encrypted data transmitted to said device 1, such as a decryption ensured based an at least one decryption key defining, at least partially, the data stored at the level of the storage means 2.

Such an encryption key can have a temporary validity, so that the display of data at the level of said receiver device 1 may require an updating of this key, namely through replacing the storage means 2.

Using conditional-test means thus allows performing the display, at the level of a device 1 dedicated to a determined user, of data this user is likely to wish and/or is entitled to see displayed at the level of its device 1.

These conditional-test means also allow displaying at least some of the collected data only to a duly authorized user.

Such an embodiment also allows contemplating various levels of authorization of such a display, which consist, for example, in authorizing the display of a determined part or of another part of the transmitted data. This allows customizing the data likely to be displayed at the level of said receiver device 1.

In the following part of the description are given a number of possible applications of this invention, whereby it should be known that the latter is in no way limited to such applications.

Application 1

This invention will find a particular application in the field of winning over the customers for a consumer product.

The data transmitted by the waves relate to promotional offers applied to a number of consumer products. Such data are, for example, an equivalent for the discount vouchers the customer hands over at the cash in order to receive the applicable discount.

The transmitted data are collected at the level of said device and displayed by the user who selects the products he is interested in and for which he wants to receive a discount. The data corresponding to these products is stored at the level of a chip card the user inserts, at the cash, into an appropriate reading device capable of reading, of downloading (namely of extracting from the memory) these data. The bill to be paid by the user takes into consideration the discount applied to each of the products selected and bought by the user.

This card can also contain data related to this user, such data being related, for example, to the coordinates, the consumer habits, the taste and the centers of interests . . . , of this user. Such data allow constituting the consumer profile of this user.

These data can be transmitted, for example, to the manufacturer of the products object of a promotional offer, so as to allow this manufacturer to propose to a user products. This also allows, depending on the data stored at the level of the removable memory and related to the profile of the user, to ensure the display, at the level of the receiver device, of only the data related to certain well-determined products corresponding to the profile of that user.

Application 2

By the waves are transmitted, for example, data on the stock market prices.

At the level of the receiver device can occur the display of general data related to the stock market, this as a function of determined data stored at the level of the removable storage. There can also be displayed the contents of a share portfolio a user possesses (even the value of this portfolio or of the shares the latter is comprised of), this according to the data (namely defined by at least one decryption key or the like) stored at the level of the removable storage.

Application 3

A chip card contains data related to a game of chance, namely the figures of a lottery or the like.

These figures can, for example, be chosen directly at the level of the receiver device and stored at the level of the chip card. These figures are then validated at a betting and game office and/or transmitted, namely acoustically, to a server (namely that ofthe company managing the game), this by inserting said chip card into an adequate reading device.

These figures can also be chosen and validated at said betting and game office before being stored at the level of a chip card aimed at being inserted into said receiver device.

The data corresponding to the results of the lottery drawing are transmitted by the waves and received by the receiver device. These results can be displayed at the level of this device, namely together with the amount corresponding to the figures selected and present at the level of the chip card.

We claim:

1. Method for transmitting data by electromagnetic waves comprising:
receiving by at least one receiver device, for receiving these data at a level of such a receiver device; and
displaying at least a part of these data at the level of this receiver device; wherein a display of these data is ensured before a recording of at least a part of the data received by the receiver device, being ensured at a level of removable storage means, said receiver device receiving and/or only after having checked that this display was authorized or convenient according to data previously stored in said removable storage means.

2. Method according to claim 1, wherein said data are transmitted by frequency-modulated or amplitude-modulated electromagnetic waves, these data being carried by at least one sub-carrier, namely at least one RDS sub-carrier these electromagnetic waves comprise.

3. Method according to claim 1, further comprising selecting at least a part of the data received at the level of the device, before proceeding to the storage of the selected data into the removable, storage means.

4. Method according to claim 1, wherein, when checking authorization or convenience of displaying data received by the device, a conditional-test of these data with reference to at least one piece of data previously stored at the level of the storage means is ensured.

5. Device for receiving and displaying data transmitted by electromagnetic waves, comprising:
means for receiving transmitted data;
means capable of ensuring the display of at least a part of these transmitted data; and
removable means for storing at least one piece of data corresponding to transmitted data and/or corresponding to data conditioning the display of at least one piece of transmitted data.

6. Device according to claim 6, further comprising means for allowing selecting at least a part of the data received and displayed at the level of the display means.

7. Device according to claim 6, further comprising means designed capable of ensuring storing, at the level of the storage means, at least one piece of data selected by means of the selecting means.

8. Device according to claim 7, further comprising control means for storing the selected data at the level of the storage means.

9. Device according to claim 5, further comprising means designed capable of ensuring a conditional test for controlling or not the display of at least a part of the transmitted data, according to at least one piece of data previously stored at the level of the storage means.

10. Device according to claim 9, wherein said conditional-test means are comprised of means for ensuring a comparison between at least a part of the data received by the device and at least a part of the data previously stored at the level of the storage means.

11. Device according to claim 9, wherein said conditional-test means are comprised of means for ensuring a decryption of at least one encrypted piece of data transmitted to said device, such decryption being ensured based an at least one decryption key defining, at least partially, the data recorded at the level of the storage means.

12. Device according to claim 5, wherein said removable storage means are comprised of a removable support which at least one electronic component for storing at least one piece of data is associated with.

13. Device according to claim 12, wherein said storage means is comprised of a chip card.

14. Device according to claim 5, wherein said receiver means are designed capable of receiving data transmitted by amplitude modulated and/or frequency-modulated electromagnetic waves.

15. Device according to claim 14, wherein said receiving means are designed capable of receiving data carried by at least one sub-carrier these amplitude-modulated and/or frequency-modulated electromagnetic waves comprise, namely a RDS sub-carrier.

16. Device according to claim 14, wherein said receiving means are further comprised of means designed capable of extracting numerical data, on the one hand, comprised, at least partially, of said transmitted data and, on the other hand, contained in a set of data carried by said electromagnetic waves, namely by a sub-carrier of the latter.
